(19) United States
(12) Patent Application Publication
(10) Pub. No.: US 2018/0197190 A1
(43) Pub. Date: Jul. 12, 2018

(54) LOCALIZED BUSINESS ANALYTICS

(71) Applicant: SAP SE, Walldorf (DE)

(72) Inventors: Ralph Debusmann, Ludwigsburg (DE); Michail Vasiltschenko, Schriesheim (DE); Yvonne Miklosch, Nussloch (DE); Elena Lopushenko, Kyiv (UA); Iuliia Konstantinova, Mannheim (DE); Holger Sievert, Hambruecken (DE); Jochen Geib, Speyer (DE); Benjamin Schork, Wilhelmsfeld (DE); Guenther Fischer, Nussloch (DE)

(21) Appl. No.: 15/400,455

(22) Filed: Jan. 6, 2017

(51) Int. Cl. G06Q 30/02; G06Q 10/06

(52) U.S. Cl. CPC G06Q 30/0205; G06Q 10/0637

(57) ABSTRACT

A system includes a memory and a semiconductor-based processor coupled to form logic circuits. The logic circuits provide a localization (LPN) web service to a computer application having business analytics functions, for a recommendation on how to localize the business analytics performed by the computer application to target a specific group of consumers, prepare a recommendation on reconfiguring the business analytics logic of the computer application to perform business analytics localized to target the specific group of consumers, and provide the recommendation to the computer application to set up a localized (LPN) computer application to perform business analytics targeting the specific group of consumers.

### BACKGROUND

A computer application that is hosted on a server (e.g., on a cloud computing platform) may be commonly targeted at different markets or diverse groups of users across diverse regions (e.g., groups corresponding to different languages or cultures). The application logic is most likely coded in common for all users, but may have different versions coded to address variations in the regional, cultural and personal characteristics or needs of the diverse users. For example, a version of a grocery shopping application may be coded to provide a set of locally available grocery products for a first group of users in one country while another version of the application may have to be re-coded to provide another set of locally available grocery products for a second group of users in another country.

Even if a version of the computer application is individually customized to include an application logic module to address the characteristics or needs of a particular group of users, it is unlikely such an individualized application logic module can be reused for other version of the computer application. While coding different versions of the computer application may encourage acceptance of the computer application across the different markets or groups of users, it is expensive to code and maintain the different localized versions of the computer application.

Business analytics (BA) is the practice of iterative, methodical exploration of an organization's data with emphasis on statistical analysis. Business analytics is used by companies committed to data-driven decision making. Business analytics depends on sufficient volumes of high quality data. The difficulty in ensuring data quality is integrating and reconciling data across different systems, and then deciding what subsets of data to make available for analysis. Applications rarely incorporate regional, cultural and personal information into their business analytics. If they do, such data are not reusable for different applications.

Consideration is now being given to systems and methods for localization of business analytics (BA) of a computer application.

### SUMMARY

A method for localization of a computer application to perform business analytics targeting a specific group of consumers. The computer application includes business analytics logic.

In a general aspect, the method includes providing, by a server, a localization and personalization (LPN) web service to the computer application, the computer application having business analytics logic. The method further includes receiving a call from the computer application for a recommendation on how to localize the business analytics performed by the computer application to target the specific group of consumers, preparing a recommendation on reconfiguring the business analytics logic of the computer application to perform business analytics localized to target the specific group of consumers, and providing the recommendation to the computer application to set up a localized (LPN) computer application to perform business analytics targeting the specific group of consumers.

In an aspect of the method, preparing a recommendation on reconfiguring the business analytics logic of the computer application to perform business analytics localized to target the specific group of consumers includes recommending addition of a reusable application logic module to the business analytics logic to modify the business analytics logic of the computer application to target the specific group of consumers.

In another aspect of the method, preparing a recommendation on reconfiguring the business analytics logic of the computer application to perform business analytics localized to target the specific group of consumers includes recommending an input data set to be analyzed by business analytics logic of the computer application to target the specific group of consumers.

The details of one or more implementations are set forth in the accompanying drawings and the description below. Further features of the disclosed subject matter, its nature and various advantages will be more apparent from the accompanying drawings, the following detailed description, and the appended claims.

### BRIEF DESCRIPTION OF THE DRAWINGS

FIG. 1 is a schematic block diagram illustrating an example system for localization of a business analytics application, in accordance with the principles of the present disclosure.

FIG. 2 is a schematic block diagram illustration of a system for localization and personalization of a computer application, in accordance with the principles of the present disclosure.

FIG. 3 is a schematic block diagram illustrating a microservices architecture (MSA) of a localization and personalization (LPN) service, which may be provided by a LPN service broker to a computer application at application run time, in accordance with the principles of the present disclosure.

FIG. 4 is an illustration of an example method for localization of a computer application presented to a specific group of consumers on a client computer device, in accordance with the principles of the present disclosure.

### DETAILED DESCRIPTION

Computer-implemented systems and methods for localization of a computer application are described herein.

A generic group of consumers may have characteristics (e.g., purchasing habits) that are defined, for example, by statistically averaging the characteristics of different groups of consumers over regions or countries of the world. A generic version of the computer application (e.g., a business analytics (BA) application) may include business analytics logic and functions (e.g., algorithms for Artificial Intelligence, Predictive Intelligence, and Machine Learning) that can be used for data-driven analysis and decision-making, which targets, for example, a market involving the generic group of consumers. The BA application may also include functions (e.g., retailing functions) coded to target groups of consumers, or be coupled to another computer application (e.g., a Business-to-Consumer (B2C) retail application) targeting groups of consumers. BA results (e.g., demand pattern recognition and prediction, customer behavior recognition and prediction, sentiment analysis, etc.) may help make decisions (e.g., on how and which retail functions to use) to target the groups of consumers.

To differentiate and target a specific group of consumers (e.g., a regional or cultural group of consumers), the generic BA application may be localized so that its analytics includes consideration of the specific characteristics of the specific group of consumers, in accordance with the principles of the present disclosure.

Consideration of the specific characteristics of the specific group of consumers in the analytics may be expected to provide BA results (e.g., for demand pattern recognition and prediction, customer behavior recognition and prediction, sentiment analysis, etc.) that can support localized decision-making targeting, for example, the specific market of the specific group of consumers.

In an example implementation, the generic BA application may be localized by conditioning the BA application logic (e.g., demand pattern recognition and prediction, customer behavior recognition and prediction, sentiment analysis logic, etc.) to analyze the specific characteristics of the specific group of consumers, and to provide localized BA results for the specific market of the specific group of consumers.

In some example instances, the generic BA application may be localized by using the specific characteristics of the specific group of consumers to modify or pre condition the sample or input data processed and analyzed by the BA application.

A database may include a store of data (e.g., market data, consumer characteristics, etc.) that can be used as input data to be processed and analyzed by BA application. A Localized and Personalization Service (“LPN” service) may be used to provide the specific characteristics or profiles of the specific group of consumers that can be used to modify or pre condition the input data to be processed by the BA application logic.

In other example instances, the generic BA application may be localized by including in the generic BA application one or more reusable application logic modules that are specific to the specific group of consumers, in accordance with the principles of the present disclosure. The application logic modules may, for example, make the type, scope, or metrics of the analytics dependent on the specific characteristics or profiles the specific group of consumers.

The reusable application logic modules may be “plug-in” or “add-on” type application logic modules that can be added on or attached to the generic computer application code (“core application logic”).

A database may include a store of different reusable application logic modules that may be tailored, for example, to different regional or cultural groups of consumers. The systems and methods for localization of the BA application described herein may simplify the application logic coding by using the LPN service to select and add a pre-coded reusable application logic module to the core application logic of the BA application. The reusable application logic modules may provide the logic needed to incorporate the specific characteristics or profiles (i.e., regional, cultural and personal consumer information) of the specific group of consumers in the analytics.

The localization of the application logic may be provided by a backend computer system as a remote service to localize and personalize the application logic of the BA application, which may be running on a client computer device.

The localization of the application logic may involve adding or replacing one or more application logic modules in the computer application with other application logic modules. The additions and replacements may be based on information on characteristics of the specific group of consumers. This information (which may be referred to herein as “consumer information”, “consumer profile” or “consumer metadata”) may include information on personal and cultural characteristics (e.g., the consumer's nationality, language, income, geographic location, purchasing habits, spending habits, cultural habits, etc.) of the consumers. The information on which the localization of the application logic is based may be dynamically collected in, and retrieved from, one or more databases or data stores.

The localization of the application logic for the specific group of consumers may involve applying a predetermined set of “localization” rules (“LPN rules”) to the consumer information to select recommended application logic modules that should be assigned to, or added to, the application logic so that the computer application is localized for the specific group of consumers.

The systems and methods described herein may involve using an algorithm which, at run-time, applies the LPN rules to consumer information collected from various input channels to localize the BA application for the specific group of consumers.

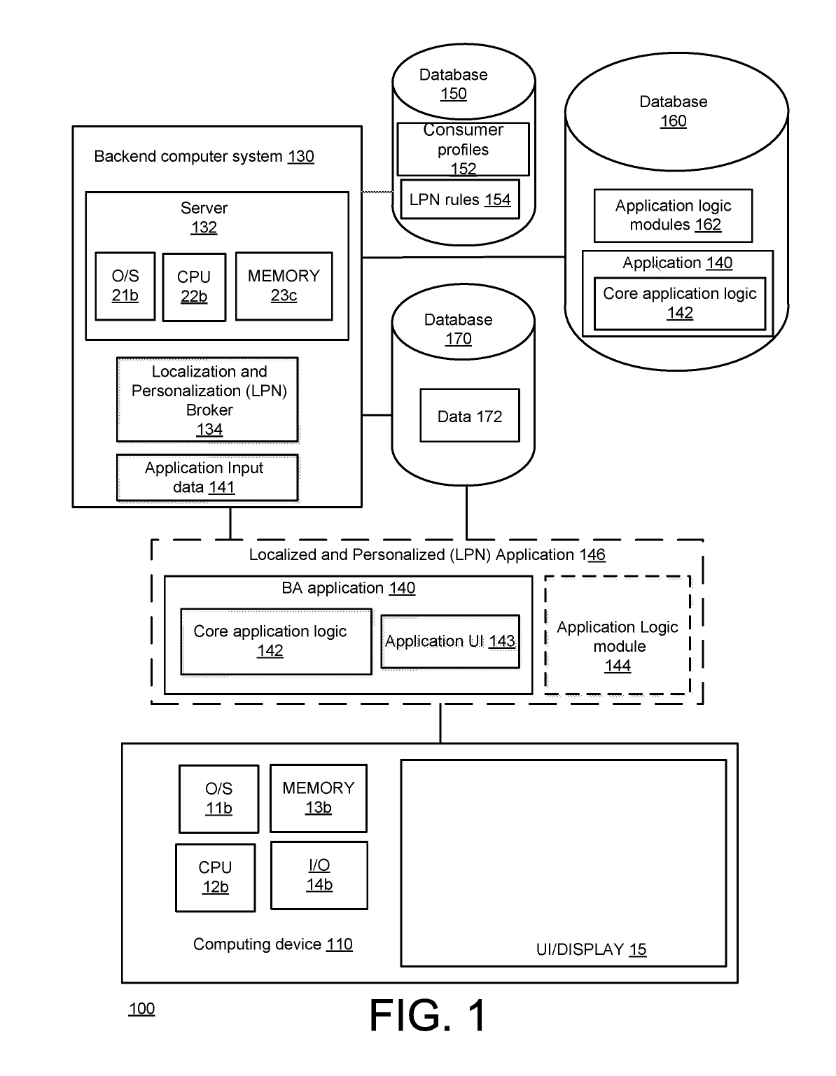

FIG. 1 is a schematic block diagram showing an example system 100 for localization of a business analytics application (e.g., BA application 140), in accordance with the principles of the present disclosure.

BA application 140 may include a core application logic 142 (e.g., for analytics) and an application UI 143. System 100 may include a backend computer system 130 connected to a client computing device 110 and one or more databases (e.g., a database 160, a database 170, and a database 150). Database 150 may include consumer profiles 152 and LPN rules 154. Database 160 may include BA application 140, which includes core application logic 142 (e.g., for analytics). Database 160 (or other database) may further include different reusable application logic modules 162 that may be used, for example, for localization of BA application 140. Database 170 (or other database) may include data 172 (e.g., market data, consumer profiles, consumer information, etc.) from which sample or input data (e.g., application input data 141) that is to be analyzed by BA application 140 can be obtained.

Client computing device 110 may, for example, include an O/S 11b, a CPU 12b, a memory 13b, and I/O 14b, and a user interface (UI) or display 15. Backend computer system 130 may include one or more computing devices (e.g., sever 132) which like client computing device 110 may include computer components such as an O/S 21b, a CPU 22b and a memory 23c, etc. Although server 132 is illustrated in the example of FIG. 1 as a single computing device, it may be understood that server 132 may represent two or more computing devices in communication with one another. Therefore, it will also be appreciated that any two or more components of system 100 may similarly be executed using some or all of the two or more computing devices in communication with one another. Conversely, it also may be appreciated that various components illustrated as being external to server 132 may actually be implemented therewith.

In system 100, BA application 140 (e.g., before it is localized) may be hosted on one or more computers (including, for example, server 132, client computing device 110 or other virtual or physical machines). BA application 140 may include application processes (e.g., core application logic 142) and a front end (e.g., application UI 143). Application UI 143 may be presented on client computing device 110 for an operator to interact with or access BA application 140. Backend computer system 130 may also include a datastore (e.g., database 170), which may store data consumed (e.g., application input data 141) or generated by BA application 140.

In system 100, BA application 140 may initially include core application logic (e.g., core application logic 142) which may include, for example, logic for generic BA functions of the application (e.g., functions such Artificial Intelligence, Predictive Intelligence, and Machine Learning, etc.).

LPN service broker 134 may use one or more micro services to retrieve the specific characteristics of the specific group of consumers. Further, LPN service broker 134 may be used to select a reusable application logic module (e.g., application logic module 144) from database 160/application logic modules 162 to localize BA application 140 for the specific group of consumers.

BA application 140 may be localized for a specific group of consumers by adding application logic module 144 to core application logic 142 to form “Localized (LPN)” application 146. LPN application 146 may be presented on client computing device 110 to the operator.

As an alternate to, or in addition to, adding application logic module 144 to core application logic 142, LPN service broker 134 may use the specific characteristics of the specific group of consumers to limit or pre condition application input data 141 to localize the analytics of BA application 140 to a specific group of consumers.

Backend computer system 130, which may be coupled to database 150 and database 160, may include processes that are configured to provide a “localization and personalization” (LPN) service to adapt or modify BA application 140 (e.g., at run time), and present it as a localized application (e.g., LPN application 146). The LPN service may be provided as a web service, for example, by a “localization” (LPN) service broker 134 in backend computer system 130. The adaptation or modification of BA application 140 as LPN application 146 for a specific group of consumers may be based, for example, on consumer specific data (e.g., consumer profiles 152) retrieved from database 150 or other data stores. The adaptation or modification of BA application 140 as LPN application 146 for the specific group of consumers may involve implementing pre-determined localization rules (e.g., LPN rules 154) for various use contexts.

In an example implementation, LPN service broker 134 may have a microservices architecture (MSA) and may be configured to provide the LPN web service as a collection of one or more microservices (e.g., Base Microservice, Geographic Microservice, Spending Power Microservice, Events Microservice, etc.). In the example implementation, the collection of one or more microservices may include at least the Base Microservice while the other microservices (e.g., Geographic Microservice, Spending Power Microservice, Events Microservice, etc.) may be optional. The microservices may have access to consumer information (e.g., consumer profiles 152/database 150) and may accordingly generate respective recommendations for adapting or modifying BA application 140 as LPN application 146 for the specific group of consumers. In an example implementation, the recommendations may be delivered by LPN service broker 134 to BA application 140 using push technology (e.g., server push) communications.

Example use cases of the localization and personalization of localization of BA application 140 (e.g., using system 100) are described below.

Machine Learning for Market Segmentation

Market segmentation is the breaking down of a market into smaller groups with the intention of promoting products or service differently to each of them. Market segmentation allows marketing to become more specific.

In an example use case, BA application 140 may include machine learning algorithms for optimizing target group segmentation. The machine learning algorithms may use of a set of training data (e.g., selected from data 172) to train and improve the statistical models involved, for example, for target group segmentation. If the set of training data is small or arbitrarily chosen, the model parameters learnt from machine learning may be coarse-grained (high bias/low variance) and thus cannot fit unseen data well. If, on the other hand, the set of training data is large or arbitrarily chosen, the model parameters may over fit the training data (low bias/high variance). In either case, the model parameters will not properly predict, or extrapolate to fit, unseen data.

However, in system 100, LPN service broker 134 may use the specific characteristics of the specific group of consumers retrieved from (e.g., consumer profiles 152) to limit or pre condition application input data 141 to localize the analytics of BA application 140 to a specific group of consumers. The set of training data for the machine learning algorithms in BA application 140 may be properly chosen (e.g., to be of “just the right size”) by making use of a combination of regional, cultural and personal information about the specific group of consumers. It may be expected that properly selecting the set of training data for the machine learning algorithms (by consideration of the specific characteristics of the specific group of consumers) will result in machine learning of model parameters that are robust, and lead to significant optimization of target group segmentation.

Demand Patterns Recognition and Prediction

In an example use case, BA application 140 may be configured for demand patterns recognition and prediction for customers of cloud services (e.g., in sharing services like “Uber”, “AirBnB,” etc.). Statistically averaging the characteristics of different groups of consumers over regions or countries of the world would not lead to meaningful demand patterns recognition and prediction for a specific market or a specific group of consumers. However, the adaptation or modification of BA application 140 into LPN application 146 (by taking into consideration the specific characteristics of the specific group of consumers by system 100) may be expected to result in reliable demand patterns recognition and prediction for the specific market or the specific group of consumers.

Customer Behavior Recognition and Prediction

In an example use case, BA application 140 may be configured for customer behavior recognition and prediction, for example, for service providers (e.g., service providers such as German carmakers Volkswagen, Porsche or Daimler who provide car services to consumers world wide). Statistically averaging the characteristics of different groups of consumers over regions or countries of the world would not lead to meaningful customer behavior recognition and prediction for a specific market or a specific group of consumers. However, the adaptation or modification of BA application 140 into LPN application 146 (by taking into consideration the specific characteristics of the specific group of consumers by system 100) may be expected to result in reliable customer behavior recognition and prediction for the specific market and the specific group of consumers.

Customer Sentiment Analysis

In an example use case, BA application 140 may be configured to consider customer sentiment as a factor in market behavior. The customer sentiment may be gauged, for example, in response to colloquialisms used in e-commerce solutions (e.g., SAP Hybris). However, customer sentiment can vary from customer group-to-customer group. For example, in South Africa, there may be some words that denote positive sentiment, but the same words do not denote positive sentiment in other English-speaking regions. Statistically averaging customer sentiment of different groups of consumers over regions or countries of the world would not lead to meaningful assessment of customer sentiment for the e-commerce solutions. However, the adaptation or modification of BA application 140 into LPN application 146 (by taking into consideration the specific characteristics of the specific group of consumers by system 100) may be expected to result in reliable assessment of customer sentiment for the specific market and the specific group of consumers.

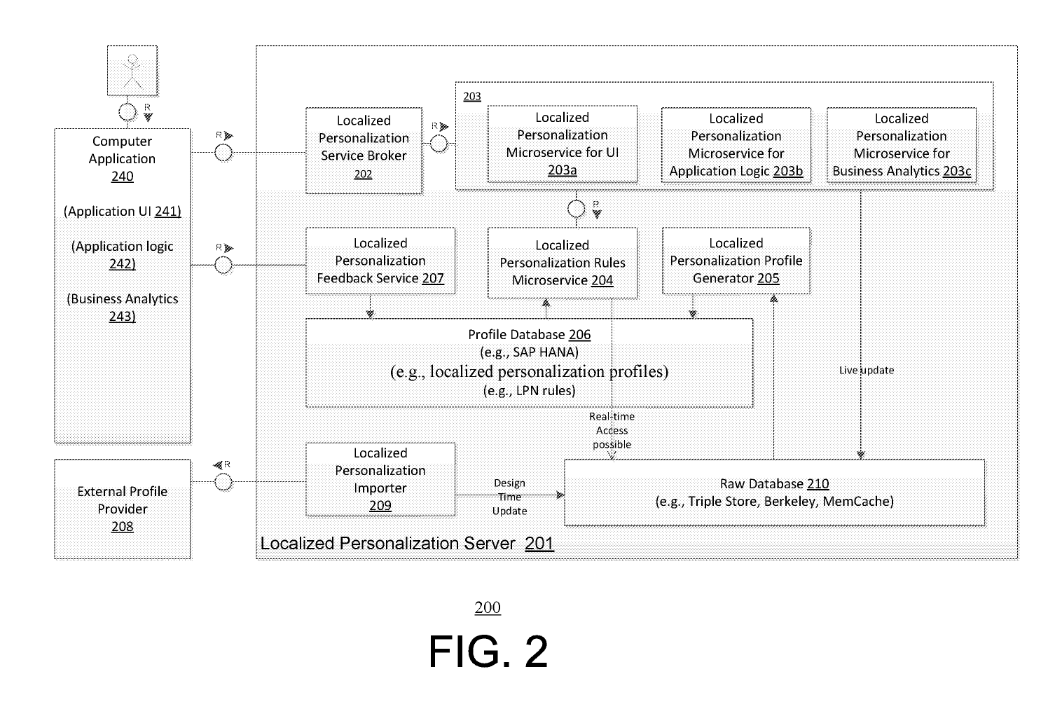

FIG. 2 is a schematic block diagram illustrating a system 200 for localization and personalization of a computer application 240, in accordance with the principles of the present disclosure. Computer application 240 may include business analytics and also include other application logic (e.g., application logic for B2C functions). In an example implementation, computer application 240 may, for example, include an application UI 241, application logic 242 and business analytics 243.

System 200 may include a localization and personalization server 201 that hosts a localization and personalization (LPN) service broker 202. LPN service broker 202 may be configured to call one or more microservices 203 to localize and or personalize computer application 240. The one or more microservices 203 can include a Localized Personalization Microservice for Business Analytics 203c. The one or more microservices 203 may also include a Localized Personalization Microservice for UI 203a, and a Localized Personalization Microservice for application logic 203b. LPN service broker 202 may utilize the one or more microservices 203 to localize and personalize one or more aspects (e.g., business analytics, application UI or application logic) of computer application 240 according to user profiles or consumer profiles (e.g., localized personalization profiles), which may be stored, for example, in a profile data base 206 (e.g., SAP HANA). LPN service broker 202 may be configured to utilize a localized personalization rules microservice 204 to retrieve a target set of LPN rules and a target user profile or consumer profile (e.g., a target localized personalization profile) from profile data base 206. LPN service broker 202 may according to the target LPN rules call the one or more microservices 203 to localize and personalize one or more aspects (e.g., business analytics, application UI and application logic) of computer application 240.

Further aspects of system 200 may relate to creation of the localized personalization profiles from user information, consumer information, and or market information (collectively “raw data”) which may be stored in a raw database 210. Raw database 210 may, for example, be a Triple Store, a Berkley or a Memcache database. The raw data may be imported by a localized personalization importer 209 from external data providers (e.g., external profile provider 208) and stored in raw database 210. Localized personalization importer 209 may update raw database 210, for example, at design time so that the latest data is available for localizing and or personalizing computer application 240.

The raw data in raw database 210 may be processed, for example, by a localized personalization profile generator 205 to create or update the localized personalization profiles that are stored in profile data base 206. The localized personalization profiles that are stored in profile data base 206 may also be created or updated by a localized personalization feedback service 207 with feedback received from computer application 240.

In some implementations, raw database 210 may be directly accessed, by localized personalization rules microservice 204 to retrieve LPN rules in real time or near real time from the raw data. Similarly, in some implementations, raw database 210 may also be directly accessed by localized personalization microservice for business analytics 203c to retrieve sample or input data for business analytics in real time or near real time from the raw data.

Commonly-assigned U.S. patent application Ser. No. 15/199,126 describes systems and methods involving a LPN service broker that utilizes a number of microservices to personalize and localize an application UI, and commonly-assigned U.S. patent application Ser. No. 15/359,335 describes systems and methods involving a LPN service broker (e.g., LPN service broker 334) that that utilizes a number of microservices to personalize and localize application logic.

The principles of operation of the systems and methods described in the foregoing commonly-assigned patent applications may be incorporated in system 200 for personalizing and localizing different aspects (e.g., application UI 241, application logic 242, and business analytics 243) of computer application 240. For example, LPN service broker 202 (FIG. 2) that provides one or more microservices 203 (including Localized Personalization Microservice for UI 203a, Localized Personalization Microservice for application logic 203b, and Localized Personalization Microservice for Business Analytics 203c) may have the same, or similar, structure and functions as LPN service broker 334 described in U.S. patent application Ser. No. 13/359,335.

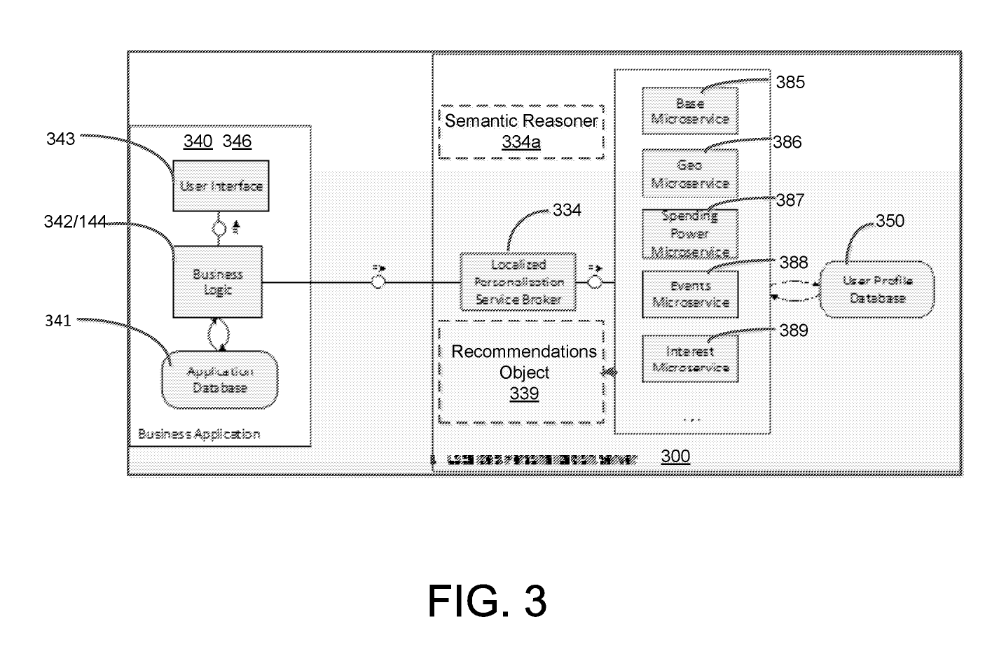

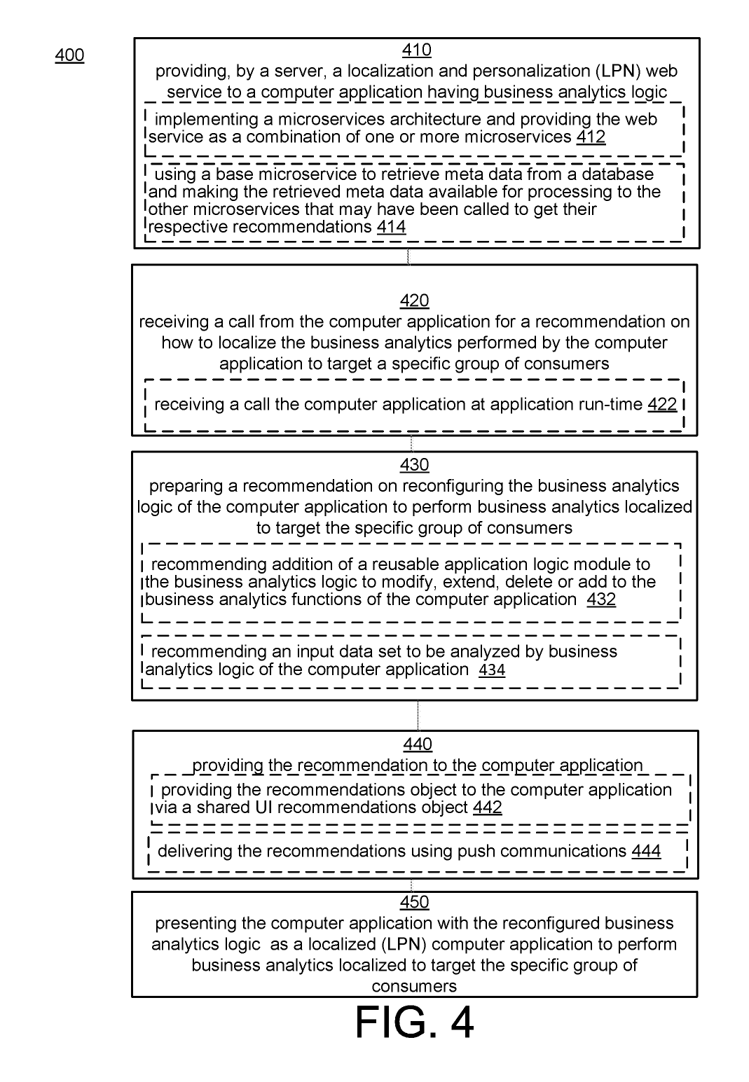

For ease of reference, portions of the description of LPN service broker 334 in U.S. patent application Ser. No. 15/359,335 are adapted and reproduced below (FIG. 4 of the previous application is adapted as FIG. 3 herein).

FIG. 3 is a schematic block diagram illustrating the microservices architecture (MSA) of an example LPN web service 300, which may be provided by LPN service broker 334 to computer application 340 at application run time. LPN web service 300 may, for example, include one or more microservices (e.g., Base Microservice 385, Geographic Microservice 386, Spending Power Microservice 387, Events Microservice 388, Interest Microservice 389, etc.) for recommending which reusable application logic modules (e.g., application logic module 144) should be selected from application logic modules (which may be stored in a database) to be added to computer application 340 for a particular localization and personalization scenario (e.g., a particular user or group of users). Each of the microservices may generate a respective recommendation by processing data (e.g., user profiles, consumer profiles, and other information stored in user profiles database 350) related to the particular user or group of users and implementing pre-determined localization and personalization rules (e.g., LPN rules).

In an example implementation, Geographic Microservice 386 may be configured to provide recommendations for which reusable application logic modules (e.g., application logic module 144) to attach to the core logic of computer application 340 based on the geography of the particular user (or a particular group of users). The recommendation may account for regional, cultural and personal preferences, for example, in naming geographic locations on a map, in choices of color, in the Operating Systems used, etc. The recommendations may be based on applying a LPN rule based on the particular user's likely sensitivities or preferences (as determined from a user profile stored in user profiles database 350) for geographical names. For example, if the particular user has Argentinian citizenship, Geographic Microservice 386 may recommend that a map should labelled “Malvinas” in accordance with the preferred Argentinian name for the islands instead of “Falkland Islands”.

Further, in the example implementation, Spending Power Microservice 387 may be configured to provide recommendations for which reusable application logic modules (e.g., application logic module 144) to attach to the core logic of computer application 340 (e.g., a B2C application) based on information on the spending power of the particular user or group of users. The information on the spending power (e.g., income relative to prices of products or service) may be determined from a user profile stored in user profiles database 350. The recommendations may account for the different spending powers of different consumers so that computer application 340 (e.g., a B2C application) can be targeted to specific consumers individually or by region.

Further, in the example implementation, Events Microservice 388 may be configured to localize and personalize the application logic of computer application 340 by incorporating knowledge about current events, or recurring events such as local holidays and festivals (e.g. Christmas, Ramadan, Diwali, etc.) in the application logic of computer application 340. Events Microservice 388 may to be configured to recommend which reusable application logic modules (e.g., application logic module 144) to attach to the core logic of computer application 340 (e.g., a B2C application) based on information on events, which may affect the particular user or groups of users targeted by computer application 340. Computer application 340 (e.g., a B2C application) may be localized and personalized, for example, to market specific products that may be suitable or appropriate for the local holidays and festivals (e.g. Christmas, Ramadan, Diwali, etc.).

Further, in the example implementation, Interest Microservice 389 may be configured to localize and personalize the application logic of computer application 340 by incorporating knowledge about the social, political, or cultural interests of the particular users or groups of users. Events Microservice 388 may to be configured recommend which reusable application logic modules (e.g., application logic module 144) to attach to the core logic of computer application 340 (e.g., a B2C application) based on information on the interests of the particular user or groups of users targeted by computer application 340. Computer application 340 (e.g., a news reporting application) may be localized and personalized, for example, to filter or rank new stories based on interests of the particular user or groups of users. For example, stories about the European Championships in soccer may be filtered out as not being of interest to users in the Americas to whom the Copa America tournament may be more important. As another example, computer application 340 (e.g., an automatic music playlist creating application) may be localized and personalized to create a customized streaming music playlist for French listeners who may prefer French artists.

LPN web service 300 may include any number of additional microservices, or alternate microservices other than the examples shown in FIG. 3. LPN web service 300 may, for example, include an Opting-Out Microservice, a Buy Local/Regional Products Microservice, an Offer Filtering Microservice, etc.

The Opting-Out Microservice may, for example, be configured to localize and personalize the application logic of computer application 340 (e.g., a B2C application) to automatically exclude certain products from being displayed to a user based on known user likes or dislikes. For example, if a customer is unhappy with “XYZ” brand products bought in the past, the Opting-Out Microservice may recommend an additional application logic module to exclude the XYZ brand products from being marketed to the user.

The Buy Local/Regional Products Microservice may, for example, be configured to localize and personalize the application logic of computer application 340 (e.g., a B2C application) to preferentially display products that are, for example, produced locally to users who are likely to preferentially consume locally produced products over products that are produced elsewhere. In another example, the Buy Local/Regional Products Microservice may, for example, be configured to localize and personalize the application logic of computer application 340 (e.g., a B2C application) to exclude display of products that originate from regions that the users are likely to avoid or boycott.

The Offer Filtering Microservice may, for example, be configured to localize and personalize the application logic of computer application 340 (e.g., a B2C application) to disable communications that the user may find annoying or irritating. For example, if a user has already purchased a particular product, the Offer Filtering Microservice may, for example, be used to localize and personalize the application logic of computer application 340 (e.g., a B2C application) to disable repeated communications (e.g., communications comparing better products or offering better prices for the particular product) which may irritate the user.

With renewed reference to FIG. 3, in operation, computer application 340 may call LPN service broker 334 to get recommendations on which reusable application logic module (e.g., application logic module 144) to attach to the core logic of computer application 340 to localize and personalize computer application 340 for a particular user or group of users. In example implementations, either computer application 340 itself or other component of a backend computer system or a client computing device (on which application 340 is hosted) may call LPN service broker 334 to get the recommendations for localizing and personalizing computer application 340. The call may be for a specific micro service or recommendation type (e.g., Geographic recommendation) or for a compound object of different micro services or recommendation types.

In response to the call, LPN service broker 334 may activate or call one or more of the individual microservices (e.g., Base Microservice 385, Geographic Microservice 386, Spending Power Microservice 387, Events Microservice 388, Interest Microservice 389, etc.) to get the recommendations for localizing and personalizing computer application 340.

In an example implementation, a called microservice (e.g., Events Microservice 388) may retrieve user-related information from the user profile database 350, which information may be shared by LPN service broker 334 with other microservices (e.g., Base Microservice 385, Geographic Microservice 386, Spending Power Microservice 387, etc.). Such sharing of retrieved user-related information may reduce the number of queries made by individual microservices to retrieve user-related information from user profiles stored in user profiles database 350.

Further, in some instances, the user-related information retrieved from user profiles stored in user profiles database 350 (e.g., retrieved by Geographic Microservice 386) may be analyzed (e.g., by logical reasoning) to infer additional facts about a user that may be useful for localizing and personalizing computer application 340. These additional facts may or may not be explicitly stored in user profiles in user profile database 350. In an example implementation, LPN service broker 334 may include, or be coupled to, a “logical or semantic reasoner” (e.g., semantic reasoner 334a). Semantic reasoner 334a may be configured to process the user-related information retrieved from user profiles in user profile database 350 to infer the additional facts that are not explicitly included in the retrieved user-related information or stored in user profile database 350.

Semantic reasoner 334a (which, for example, may be based on “semantic web technologies”) may be configured to access one or more knowledge bases, which may represent facts, for example, about computer usage, cultures, and human behavior, etc. Semantic reasoner 334a may reason about those facts and use rules and other forms of logic to infer additional facts that may be relevant, for example, to the user's present circumstances or context (e.g. location, device use, connectivity, history, etc.).

Semantic reasoner 334a may be configured to process the user-related information retrieved from user profiles stored in user profiles database 350 to determine the user's present circumstances and to discover or infer additional facts (e.g., from the knowledge bases) that may be relevant to customizing and personalizing computer application 340 based on the user's specific circumstances (e.g. location, device use, connectivity, history, etc.) at the time of the call to LPN service broker 334 to get the recommendations on which one or more reusable application logic modules (e.g., application logic module 144) to attach to the core logic of computer application 340 to localize and personalize computer application 340 for a particular user or group of users.

As an example of the operation of semantic reasoner 334a, the user-related information retrieved from user profiles stored in user profiles database 350 may include the fact that the user is located, for example, in South Africa. Semantic reasoner 334a may discover, for example, from a knowledge base, the fact that South Africa has poor quality Internet connections. Semantic reasoner 334a may logically infer from these facts (i.e. that the user is located in South Africa and that South Africa has poor quality internet connections) the additional fact: the user has a poor quality internet connection that is prone to frequent interruptions or breaks.

LPN service broker 334/semantic reasoner 334a may then, for example, apply a LPN rule for internet connection quality to this logically inferred additional fact (which may or may not be stored in a database 350) to recommend disabling streaming video features in computer application 340 for localizing and personalizing computer application 340 for the user.

In an example implementation, LPN service broker 334 may always first call Base Microservice 385 to retrieve user-related information from the user profiles stored in database 350. LPN service broker 334 may then call one or more of the other individual microservices (e.g., Geographic Microservice 386, Spending Power Microservice 387, Events Microservice 388, Interest Microservice 389, etc.) to get the their recommendations for localizing and personalizing the computer application. The user-related information retrieved by the first called Base Microservice may be made available for processing to the other microservices that may have also been called to get their respective recommendations. Alternatively or additionally, the LPN service broker 334/semantic reasoner 334a may process the user-related information to logically infer additional facts useful for recommending features for localizing and personalizing computer application 340.

In an example implementation, LPN service broker 334 may first receive the base recommendations from the Base Microservice, and then the additional recommendations from the one or more of the other individual microservices (e.g., Geographic Microservice 386, Spending Power Microservice 387, Events Microservice 388, Interest Microservice 389, etc.). LPN service broker 334 may combine and store the respective recommendations received from the individual microservices in a shared object (e.g., recommendations object 339), which is then returned to computer application 340. Computer application 340 may, based on the recommendations in recommendations object 339, be localized and personalized for a particular user or group of users by attaching one or more reusable application logic modules (e.g., application logic module 144) to the core logic of computer application 340. The localized and personalized computer application 340 may be presented as LPN application 346 for the particular user or group of users on a client computing device.

In the example implementation, LPN service broker 334 may include a “recommendations object” function which for a given user and given user metadata (e.g. the user's IP address, the Browser metadata, etc.) returns a recommendations object (e.g., recommendations object 339). The returned recommendations object may include the recommendations provided by one or more of the microservices included in LPN web service 300.

It will be understood that system may utilize machine learning techniques to update or refine LPN rules stored in database 350 and other aspects of the system (e.g., semantic reasoner logic, LPN service broker, micro services, databases, etc.) to continually improve system performance and efficiency. Additional facts inferred by semantic reasoner may be incorporated in local databases and LPN rules so that repeated operation of the semantic reasoner to infer the same additional facts can be avoided. For example, based on the example semantic reasoner operation (regarding a user located in South Africa) discussed in the foregoing, machine learning may create a new LPN rule that automatically attributes low internet connection quality to all users in South Africa and recommends disabling streaming video features for localizing and personalizing computer applications for all users in South Africa, without a need to operate the semantic reasoner again to discover the fact that South Africa has poor quality internet connections or to infer the additional fact the users in South Africa have poor quality Internet connections that are prone to frequent interruptions or breaks.

With renewed reference to FIG. 1 and FIG. 2, LPN service broker 134 and LPN service broker 202 (which, for example, provides one or more microservices 203 for localizing and personalizing BA application 240) may have the same, or similar, structure and functions as LPN service broker 334 (FIG. 3) for providing not only Localized Personalization Microservice for UI 203a and Localized Personalization Microservice for application logic 203b, but also for providing Localized Personalization Microservice for Business Analytics 203c). Database 350 of FIG. 3 may be understood to correspond, for example, to database 150 or FIG. 1 and to profile database 206 of FIG. 2. Profile information stored in these databases may include not only user profiles, but also include consumer profiles and market information.

The recommendation objects (e.g., recommendation object 339) generated by LPN service broker 134 and LPN service broker 202 for localizing and personalizing BA application 140 and computer application 240, respectively, may include recommendations for which additional application logic modules (e.g., application module 144) to attach (e.g., to core application logic 142 or to Business Analytics 243) to make the type, scope, or metrics of the analytics specific to the specific group of consumers. The recommendation object (e.g., recommendation object 339) may, additionally or alternatively, include recommendations on which sets of data should be analyzed by BA application 140 or computer application 240 to make the analytics specific to the specific group of consumers.

FIG. 4 shows an example method 400 for localization of business analytics of a computer application to target a specific group of consumers, in accordance with the principles of the present disclosure.

The computer application, which may be hosted on one or more physical or virtual machines (e.g., in a cloud computing network), may initially include generic business analytics logic or functions. The business analytics of the computer application may be localized to target a specific group of consumers by adding a reusable application logic module to the initial business analytics logic. The reusable application logic module may modify, extend, delete or add to the initial functions of the computer application. Additionally or alternately, the computer application may be localized by defining the sample or input data to be analyzed by business analytics logic or functions of the computer application. In the localized computer application, the type, scope, or metrics of the business analytics may be tailored specifically to the specific group of consumers.

Method 400 includes providing, by a server, a localization and personalization (LPN) web service to a computer application having business analytics logic (410), receiving a call from the computer application for a recommendation on how to localize the business analytics performed by the computer application to target a specific group of consumers (420), preparing a recommendation on reconfiguring the business analytics logic of the computer application to perform business analytics localized to target the specific group of consumers (430); providing the recommendations to the computer application (440); and presenting the computer application with the reconfigured business analytics logic as a localized (LPN) computer application to perform business analytics localized to target the specific group of consumers (450).

In method 400, preparing a recommendation on reconfiguring the business analytics logic of the computer application to perform business analytics localized to target the specific group of consumers 430 may include recommending addition of a reusable application logic module to the business analytics logic to modify the business analytics functions of the computer application to target the specific group of consumers (432). Alternately or additionally, preparing a recommendation on reconfiguring the business analytics logic of the computer application to perform business analytics localized to target the specific group of consumers 430 may include recommending an input data set to be analyzed by business analytics logic of the computer application to perform business analytics localized to target the specific group of consumers (434). When the business analytics includes machine learning of a model, recommending the input data set 434 includes recommending a training data set for the machine learning of the model.

In method 400, providing, by a server, a combined localization and personalization (LPN) web service to the computer application 410 may include implementing a microservices architecture (MSA) and providing the web service as a combination of one or more microservices (412). Each of the microservices may be configured to provide a respective recommendation of which one or more reusable application logic modules to include in the LPN application.

Providing the web service as a combination of one or more microservices 412 may include using a base microservice to retrieve user metadata from a database and making the retrieved metadata available for processing to the other microservices that may have also been called to get their respective recommendations (414). Method 400 may further include combining the respective recommendations received from the individual microservices in a shared object.

Receiving a call from the computer application for a recommendation on how to localize the business analytics performed by the computer application to target the specific group of consumers 420 may include receiving the call at application run-time (422).

In method 400, providing the recommendation to the computer application 440 may include providing the recommendations to the computer application via a shared recommendations object (442). Further, providing the recommendation to the computer application 440 may include delivering the recommendations using push communications (444).

In method 400, preparing a recommendation on reconfiguring the business analytics logic of the computer application to perform business analytics localized to target the specific group of consumers may include applying a pre-determined LPN rule to profile information to select one or more reusable application logic modules to recommend for inclusion in the computer application and or to select an input data set to be analyzed by business analytics logic of the computer application to target the specific group of consumers. Further, applying a pre-determined LPN rule to profile information may include retrieving metadata on one or more of personal, social, cultural and behavioral characteristics of the specific group of consumers.

The various systems and techniques described herein may be implemented in digital electronic circuitry, or in computer hardware, firmware, or in combinations of thereof. The various techniques may implemented as a computer program product, i.e., a computer program tangibly embodied in a non-transitory machine readable storage device, for execution by, or to control the operation of, data processing apparatus, e.g., a programmable processor, a computer, or multiple computers.

Method steps may be performed by one or more programmable processors executing a computer program. Method steps also may be performed by, and an apparatus may be implemented as, logic circuitry or special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magnetooptical disks, or optical disks. Information carriers suitable for embodying computer program instructions and data include all forms of nonvolatile memory, including by way of example semiconductor memory devices, e.g., EPROM, EEPROM, and flash memory devices; magnetic disks, e.g., internal hard disks or removable disks; magnetooptical disks; and CDROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a backend component, e.g., as a data server, or that includes a middleware component, e.g., an application server, or that includes a frontend component, e.g., a client computer having a graphical user interface or a Web browser through which a user can interact with an implementation, or any combination of such backend, middleware, or frontend components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A method for localization of a computer application to perform business analytics targeting a specific group of consumers, the method comprising:
providing, by a server, a localization and personalization (LPN) web service to the computer application, the computer application having business analytics logic;
receiving a call from the computer application for a recommendation on how to localize the business analytics performed by the computer application to target the specific group of consumers;
preparing a recommendation on reconfiguring the business analytics logic of the computer application to perform business analytics localized to target the specific group of consumers; and
providing the recommendation to the computer application to set up a localized (LPN) computer application to perform business analytics targeting the specific group of consumers.

2. The method of claim 1, wherein preparing a recommendation on reconfiguring the business analytics logic of the computer application to perform business analytics localized to target the specific group of consumers includes recommending addition of a reusable application logic module to the business analytics logic to modify the business analytics logic of the computer application to target the specific group of consumers.

3. The method of claim 1, wherein preparing a recommendation on reconfiguring the business analytics logic of the computer application to perform business analytics localized to target the specific group of consumers includes recommending an input data set to be analyzed by business analytics logic of the computer application to target the specific group of consumers.

4. The method of claim 3, wherein the business analytics includes machine learning of a model, and wherein recommending the input data set includes recommending a training data set for the machine learning of the model.

5. The method of claim 1, wherein providing the recommendation to the computer application includes providing the recommendation to the computer application via a shared recommendations object.

6. The method of claim 1, wherein providing the recommendation to the computer application includes delivering the recommendation using push communications.

7. The method of claim 1 further comprising presenting the computer application with the reconfigured business analytics logic as a localized (LPN) computer application to perform business analytics localized to target the specific group of consumers.

8. The method of claim 1, wherein receiving a call from the computer application includes receiving the call at application run-time.

9. The method of claim 1, wherein preparing a recommendation on reconfiguring the business analytics logic of the computer application to perform business analytics localized to target the specific group of consumers includes applying a pre-determined LPN rule to profile information to select one or more reusable application logic modules to recommend for inclusion in the computer application and or to select an input data set to be analyzed by business analytics logic of the computer application to target the specific group of consumers.

10. The method of claim 9, wherein applying a pre-determined LPN rule to profile information includes retrieving metadata on one or more of personal, cultural and behavioral characteristics of the specific group of consumers.

11. A system for localization of a computer application to perform business analytics targeting a specific group of consumers, the system comprising a memory and a semiconductor-based processor, the memory and the processor forming one or more logic circuits configured to:
provide a localization and personalization (LPN) web service to the computer application, the computer application having business analytics logic;
receive a call from the computer application for a recommendation on how to localize the business analytics performed by the computer application to target the specific group of consumers;
prepare a recommendation on reconfiguring the business analytics logic of the computer application to perform business analytics localized to target the specific group of consumers; and
provide the recommendation to the computer application to set up a localized (LPN) computer application to perform business analytics targeting the specific group of consumers.

12. The system of claim 11, wherein the logic circuits are configured to recommend addition of a reusable application logic module to the business analytics logic to modify the business analytics logic of the computer application to target the specific group of consumers.

13. The system of claim 11, wherein the logic circuits are configured to recommend an input data set to be analyzed by business analytics logic of the computer application to target the specific group of consumers.

14. The system of claim 13, wherein the business analytics includes machine learning of a model, and wherein the logic circuits are configured to recommend a training data set for the machine learning of the model.

15. The system of claim 11, wherein the logic circuits are configured to return the recommendation to the computer application via a shared recommendations object.

16. The system of claim 11, wherein the logic circuits are configured to return the recommendations using push communications.

17. The system of claim 11, wherein the logic circuits are configured to present the computer application with the reconfigured business analytics logic as a localized (LPN) computer application to perform business analytics localized to target the specific group of consumers.

18. The system of claim 11, wherein the logic circuits are configured to receive the call from the computer application at application run-time.

19. The system of claim 11, wherein the logic circuits are configured to prepare the recommendation on reconfiguring the business analytics logic of the computer application to perform business analytics localized to target the specific group of consumers by applying a pre-determined LPN rule to profile information to select one or more reusable application logic modules to recommend for inclusion in the computer application and or to select an input data set to be analyzed by business analytics logic of the computer application to target the specific group of consumers.

20. The system of claim 19, wherein the logic circuits are configured to apply the pre-determined LPN rule to profile information by retrieving metadata on one or more of personal, cultural and behavioral characteristics of the specific group of consumers.
